(19) United States
(12) Patent Application Publication
(10) Pub. No.: US 2013/0249670 A1
(43) Pub. Date: Sep. 26, 2013

(54) DOOR LOCK SYSTEM

(71) Applicant: Jung-Bok Lee, Chungbuk (KR)

(72) Inventor: Jung-Bok Lee, Chungbuk (KR)

(73) Assignee: GETRON CO., LTD., Cheongju-si, Chungbuk (KR)

(21) Appl. No.: 13/883,407

(22) PCT Filed: Dec. 8, 2011
(86) PCT No.: PCT/KR2011/009473

§ 371 Date: May 3, 2013

(30) Foreign Application Priority Data
Dec. 9, 2010 (KR) 10-2010-0125635

(51) Int. Cl. G08C 19/00

(52) U.S. Cl. CPC G08C 19/00
USPC 340/5.61

(57) ABSTRACT

Provided is a door lock system, which can control a door lock using a user's own terminal without regard to kinds of the user's terminal and mobile service providers that the user's terminal has been registered. The door lock system includes: an entrance door provided at one side of a building; a door lock provided at one side of the entrance door for controlling opening and closing of the entrance door; and a terminal for providing a communication signal to the door lock through communication with the door lock.

### BACKGROUND OF THE INVENTION

1. Field of the Invention

The present invention relates to a door lock system.

2. Background Art

In general, electronic door locks have been provided in order to make up for the weakness of traditional door locks to which keys are used and to enhance convenience in use.

Recently, studies on a door lock system for preventing theft of a key for the door lock and an illegal use of the entrance door and for maximizing security and convenience by controlling the door lock using a user's own terminal have been continued.

### SUMMARY OF THE INVENTION

Accordingly, the present invention has been made to solve the above-mentioned problems occurring in the prior arts, and it is an object of the present invention to provide a door lock system, which can control a door lock using a user's own terminal without regard to kinds of the user's terminal and mobile service providers that the user's terminal has been registered.

It is another object of the present invention to provide a door lock system, which can control the door lock remotely when there is a visitor who does not have the terminal whose phone number is registered in the door lock.

It is a further object of the present invention to provide a door lock system, which can control the door lock using the user's own terminal without regard to kinds of the terminal if the terminal can execute a door lock application.

It is a still further object of the present invention to provide a door lock system, which can preclude a person, who does not have a registered terminal, from controlling the door lock because identification information of a terminal of a person who will gain admission has been registered in advance.

It is another object of the present invention to provide a door lock system, which can preclude a person, who does not have a registered terminal, from controlling the door lock because identification information of a terminal of a person who will gain admission has been registered in advance, and which can prevent the person, who does not have the registered terminal, from stealing the registered terminal and illegally using the door because a secrete access number has been registered in advance.

It is a further object of the present invention to provide a door lock system, which can preclude a person, who does not have a registered terminal, from controlling the door lock because identification information of a terminal of a person who will gain admission has been registered in advance, which prevents communication between the door lock and a terminal to which a network key of the door lock was not set because the network key of the door lock has been set to the user's terminal in advance, and which can prevent the person, who does not have the registered terminal, from stealing the registered terminal and illegally using the door because a secrete access number has been registered in advance, thereby maximizing security.

To achieve the above objects, the present invention provides a door lock system including: an entrance door provided at one side of a building; a door lock provided at one side of the entrance door for controlling opening and closing of the entrance door; and a terminal for providing a communication signal to the door lock through communication with the door lock.

The door lock system according to the present invention has the following effects.

First, the door lock system can control the door lock using the user's own terminal without regard to kinds of the user's terminal and mobile service providers that the user's terminal has been registered.

Second, the door lock system can control the door lock remotely when there is a visitor who does not have the terminal whose phone number is registered in the door lock.

Third, the door lock system can control the door lock using the user's own terminal without regard to kinds of the terminal if the terminal can execute a door lock application.

Fourth, the door lock system can preclude a person, who does not have a registered terminal, from controlling the door lock because identification information of a terminal of a person who will gain admission has been registered in advance.

Fifth, the door lock system can preclude a person, who does not have a registered terminal, from controlling the door lock because identification information of a terminal of a person who will gain admission has been registered in advance, and prevent the person, who does not have the registered terminal, from stealing the registered terminal and illegally using the door because a secrete access number has been registered in advance.

Sixth, the door lock system can preclude a person, who does not have a registered terminal, from controlling the door lock because identification information of a terminal of a person who will gain admission has been registered in advance, prevent communication between the door lock and a terminal, to which a network key of the door lock was not set, because the network key of the door lock has been set to the user's terminal in advance, and prevent the person, who does not have the registered terminal, from stealing the registered terminal and illegally using the door because a secrete access number has been registered in advance, thereby maximizing security.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a door lock system according to a first preferred embodiment of the present invention;

FIG. 2 is a block diagram of a door lock system according to a second preferred embodiment of the present invention;

FIG. 3 is a block diagram of a door lock system according to third and fourth preferred embodiments of the present invention;

FIG. 4 is a block diagram of a door lock system according to a fifth preferred embodiment of the present invention;

FIG. 5 is a block diagram of a door lock system according to a sixth preferred embodiment of the present invention;

FIG. 6 is a block diagram of a door lock system according to seventh, eighth and ninth preferred embodiments of the present invention;

FIG. 7 is a block diagram of a door lock system according to tenth, eleventh and twelfth preferred embodiments of the present invention;

FIG. 8 is a block diagram of a door lock system according to thirteenth and fourteenth preferred embodiments of the present invention;

FIG. 9 is a block diagram of a door lock system according to fifteenth and sixteenth preferred embodiments of the present invention; and

FIG. 10 is a block diagram of a door lock system according to seventeenth, eighteenth, nineteenth and twentieth preferred embodiments of the present invention;

### DETAILED DESCRIPTION OF THE PREFERRED EMBODIMENT

Reference will be now made in detail to the preferred embodiment of the present invention with reference to the attached drawings.

### Embodiment 1

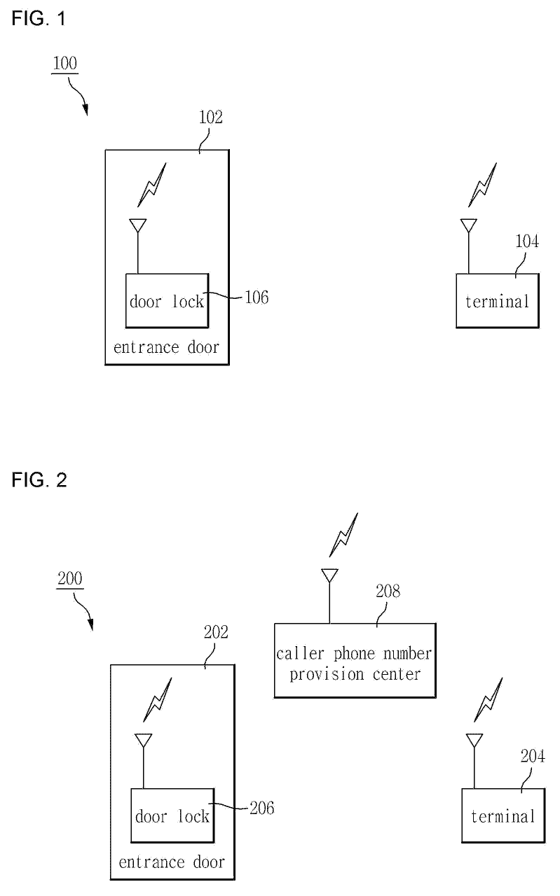

FIG. 1 is a block diagram of a door lock system according to a first preferred embodiment of the present invention.

Referring to FIG. 1, the door lock system 100 according to the first preferred embodiment of the present invention includes an entrance door 102, a terminal 104, and a door lock 106.

The entrance door 102 is not illustrated in the drawing, but is provided at one side of a building (not shown).

The door lock 106 is provided at one side of the entrance door 102 for controlling opening and closing of the entrance door 102.

Moreover, the door lock 106 includes a network key previously set, and executes communication with the terminal 104 when the network key received from the terminal 104 is agreed with the previously set network key.

The terminal 104 executes communication with the door lock 106 so as to provide a communication signal to the door lock 106.

Here, the terminal 104 may be at least one of a telephone and a remote controller.

In this instance, in the case that the terminal 104 is the telephone, the terminal 104 may be at least one of a mobile communication terminal, a wire phone, a wire and wireless IP phone, and a smart phone.

Furthermore, in the case that the terminal 104 is the remote controller, the terminal 104 may be at least one of a Pc having a phone number, a mobile PC having a phone number, and a special device having a phone number.

In this instance, in the case that the terminal 104 is the remote controller, the terminal 104 may include at least one of a PSTN phone module (not shown), a mobile communication phone module (not shown), and a wire and wireless IP phone module (not shown).

Additionally, the terminal 104 may manipulate the door lock 106 remotely so as to register a phone number of a new terminal, and can check, change and delete the phone number of the terminal which has been previously registered in the door lock 106.

In addition, the terminal 104 may manipulate the door lock 106 remotely so as to register a new secrete access number, and can check, change and delete the secrete access number which has been previously registered in the door lock 106.

In the meantime, not shown in the drawing, but the entrance door 102, the terminal 104 and the door lock 106 of the door lock system according to the first preferred embodiment of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 106 of the door lock system according to the first preferred embodiment of the present invention may include an Internet sharer (not shown), which is means for sharing the Internet, in an integrated type or a separated type.

### Embodiment 2

FIG. 2 is a block diagram of a door lock system according to a second preferred embodiment of the present invention.

Referring to FIG. 2, the door lock system 200 according to the second preferred embodiment of the present invention includes an entrance door 202, a terminal 204, a door lock 206, and a caller phone number provision center 208.

The entrance door 202 is not illustrated in the drawing, but is provided at one side of a building (not shown).

The door lock 206 is provided at one side of the entrance door 202 for controlling opening and closing of the entrance door 202.

Moreover, the door lock 206 includes a network key previously set, and executes communication with the terminal 204 when the network key received from the terminal 204 is agreed with the previously set network key.

The terminal 204 executes communication with the door lock 206 so as to provide a communication signal to the door lock 206.

Here, the terminal 204 may be at least one of a telephone and a remote controller.

In this instance, in the case that the terminal 204 is the telephone, the terminal 204 may be at least one of a mobile communication terminal, a wire phone, a wire and wireless IP phone, and a smart phone.

Furthermore, in the case that the terminal 204 is the remote controller, the terminal 204 may be at least one of a PC having a phone number, a mobile PC having a phone number, and a special device having a phone number.

In this instance, in the case that the terminal 204 is the remote controller, the terminal 204 may include at least one of a PSTN phone module (not shown), a mobile communication phone module (not shown), and a wire and wireless IP phone module (not shown).

Additionally, the terminal 204 may manipulate the door lock 206 remotely so as to register a phone number of a new terminal, and can check, change and delete the phone number of the terminal which has been previously registered in the door lock 106.

Here, the terminal 204 of the door lock system 200 according to the second preferred embodiment of the present invention may include a phone number provided by a communication service provider corresponding to the communication signal.

Moreover, the door lock system 200 according to the second preferred embodiment of the present invention may further include a caller phone number provision center 208.

That is, the caller phone number provision center 208 executes communication with the terminal 204 so as to provide the phone number, which is provided by the communication service provider and sent from the terminal 204, as a caller identification service (CID: Caller ID).

Furthermore, the door lock 206 of the door lock system 200 according to the second preferred embodiment of the present invention may include a phone number provided by the communication service provider and a phone number of the previously registered terminal 204, and execute communication with the caller phone number provision center 208.

When the door lock 206 gets a call from the terminal 204, the door lock 206 of the door lock system 200 according to the second preferred embodiment of the present invention is unlocked when the phone number received from the caller phone number provision center 208 is agreed with one of the phone numbers of the previously registered terminal 204.

In the meantime, not shown in the drawing, but the entrance door 202, the terminal 204, the door lock 206, and the caller phone number provision center 208 of the door lock system 200 according to the second preferred embodiment of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 206 of the door lock system 200 according to the second preferred embodiment of the present invention may include an Internet sharer (not shown), which is means for sharing the Internet, in an integrated type or a separated type.

### Embodiments 3 and 4

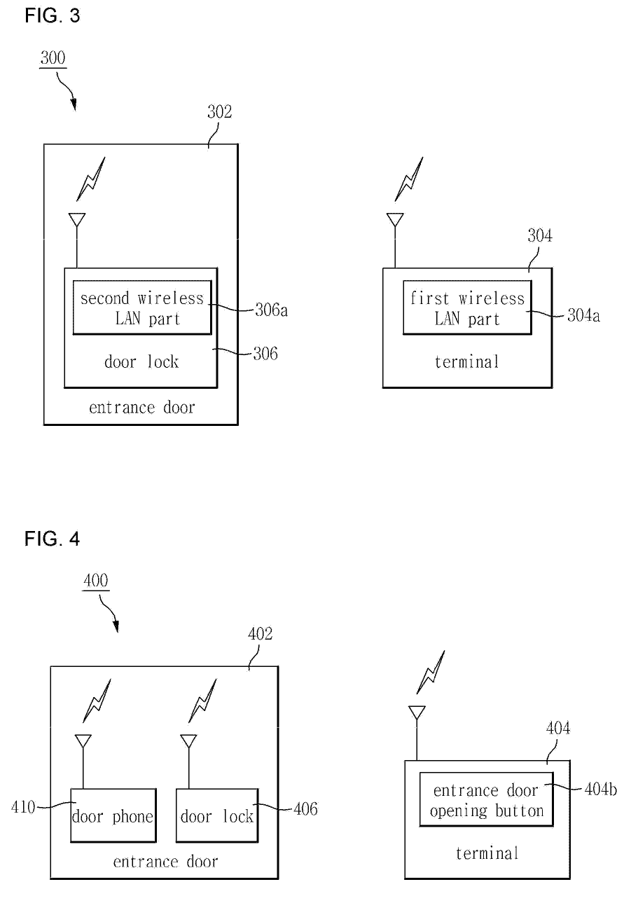

FIG. 3 is a block diagram of a door lock system according to third and fourth preferred embodiments of the present invention.

Referring to FIG. 3, the door lock system 300 according to the third and fourth preferred embodiments of the present invention includes an entrance door 302, a terminal 304, and a door lock 306.

The entrance door 302 is not illustrated in the drawing, but is provided at one side of a building (not shown).

The door lock 306 is provided at one side of the entrance door 302 for controlling opening and closing of the entrance door 302.

Moreover, the door lock 306 includes a network key previously set, and executes communication with the terminal 304 when the network key received from the terminal 304 is agreed with the previously set network key.

The terminal 304 executes communication with the door lock 306 so as to provide a communication signal to the door lock 306.

Here, the terminal 304 may be at least one of a telephone and a remote controller.

In this instance, in the case that the terminal 304 is the telephone, the terminal 304 may be at least one of a mobile communication terminal, a wire phone, a wire and wireless IP phone, and a smart phone.

Furthermore, in the case that the terminal 304 is the remote controller, the terminal 104 may be at least one of a Pc having a phone number, a mobile PC having a phone number, and a special device having a phone number.

In this instance, in the case that the terminal 304 is the remote controller, the terminal 304 may include at least one of a PSTN phone module (not shown), a mobile communication phone module (not shown), and a wire and wireless IP phone module (not shown).

In addition, the terminal 304 may manipulate the door lock 306 remotely so as to register a new secrete access number, and can check, change and delete the secrete access number which has been previously registered in the door lock 306.

Here, the terminal 304 of the door lock system 300 according to the third and fourth preferred embodiments of the present invention may further include a first wireless LAN part 304a which sends a secrete access number corresponding to the communication signal.

Moreover, the door lock 306 of the door lock system 300 according to the third and fourth preferred embodiments of the present invention may further include a second wireless LAN part 306a which has a previously registered secrete access number for executing communication with the first wireless LAN part 304a.

The door lock 306 of the door lock system 300 according to the third and fourth preferred embodiments of the present invention is unlocked when the phone number sent by the first wireless LAN part 304a of the terminal 304 and received from the second wireless LAN part 306a is agreed with one of the phone numbers of the previously registered secrete access numbers.

In the meantime, here, the terminal 304 of the door lock system 300 according to the third and fourth preferred embodiments of the present invention may further include a first wireless LAN part 304a which sends identification information corresponding to the communication signal.

Moreover, the door lock 306 of the door lock system 300 according to the third and fourth preferred embodiments of the present invention may further include a second wireless LAN part 306a having identification information of the previously registered terminal 304 for executing communication with the first wireless LAN part 304a.

In this instance, the identification information may include at least one of MAC (Media Access Control) address and an IMEI (International Mobile Equipment Identity).

The door lock 306 of the door lock system 300 according to the third and fourth preferred embodiments of the present invention is unlocked when the identification information sent from the first wireless LAN part 304a of the terminal 304 and received through the second wireless LAN part 306a when a user of the terminal 304 is in a communication range is agreed with one of the identification information of the previously registered terminal 304.

In the meantime, not shown in the drawing, but the entrance door 302, the terminal 304 and the door lock 306 of the door lock system 300 according to the third and fourth preferred embodiments of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 306 of the door lock system 300 according to the third and fourth preferred embodiments of the present invention may include an Internet sharer (not shown), which is means for sharing the Internet, in an integrated type or a separated type.

### Embodiment 5

FIG. 4 is a block diagram of a door lock system according to a fifth preferred embodiment of the present invention.

Referring to FIG. 4, the door lock system 400 according to the fifth preferred embodiment of the present invention includes an entrance door 402, a terminal 404, a door lock 406, and a door phone 410.

The entrance door 402 is not illustrated in the drawing, but is provided at one side of a building (not shown).

The door lock 406 is provided at one side of the entrance door 402 for controlling opening and closing of the entrance door 402.

Moreover, the door lock 406 includes a network key previously set, and executes communication with the terminal 404 when the network key received from the terminal 404 is agreed with the previously set network key.

The terminal 404 executes communication with the door lock 406 so as to provide a communication signal to the door lock 406.

Here, the terminal 404 may be at least one of a telephone and a remote controller.

In this instance, in the case that the terminal 404 is the telephone, the terminal 404 may be at least one of a mobile communication terminal, a wire phone, a wire and wireless IP phone, and a smart phone.

Furthermore, in the case that the terminal 404 is the remote controller, the terminal 404 may be at least one of a Pc having a phone number, a mobile PC having a phone number, and a special device having a phone number.

In this instance, in the case that the terminal 404 is the remote controller, the terminal 404 may include at least one of a PSTN phone module (not shown), a mobile communication phone module (not shown), and a wire and wireless IP phone module (not shown).

Additionally, the terminal 404 may manipulate the door lock 406 remotely so as to register a phone number of a new terminal, and can check, change and delete the phone number of the terminal which has been previously registered in the door lock 406.

Here, the door lock system 400 according to the fifth preferred embodiment of the present invention may include a door phone 410 provided at the other side of the building (not shown).

Moreover, the terminal of the door lock system 400 according to the fifth preferred embodiment of the present invention may include a phone number provided by the communication service provider, and further include a previously designated entrance door opening button 404b corresponding to a communication signal for controlling the door lock 406 in communication with the door lock 406.

Furthermore, the door lock 406 of the door lock system 400 according to the fifth preferred embodiment of the present invention may include a phone number provided by the communication service provider and a phone number of the previously registered terminal 404, and execute communication with the door phone 410.

When a visitor tries to open the entrance door 402 by a call signal through the door phone 410, the door lock 406 of the door lock system 400 according to the fifth preferred embodiment of the present invention makes a call to the terminal 404 having the phone number of the previously registered terminal 404 in synchronism with the call signal.

After that, in the case that the user of the terminal 404 having the phone number of the previously registered terminal 404 checks the visitor by a voice or an image through the door phone 410 and allows the visitor access, when the user of the terminal 404 selectively presses the previously designated entrance door opening button 404b while being on the phone, the door lock 406 of the door lock system 400 according to the fifth preferred embodiment of the present invention is unlocked.

In the meantime, not shown in the drawing, but the entrance door 402, the terminal 404, the door lock 406, and the door phone 410 of the door lock system 400 according to the fifth preferred embodiment of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 406 of the door lock system 400 according to the fifth preferred embodiment of the present invention may include an Internet sharer (not shown), which is means for sharing the Internet, in an integrated type or a separated type.

### Embodiment 6

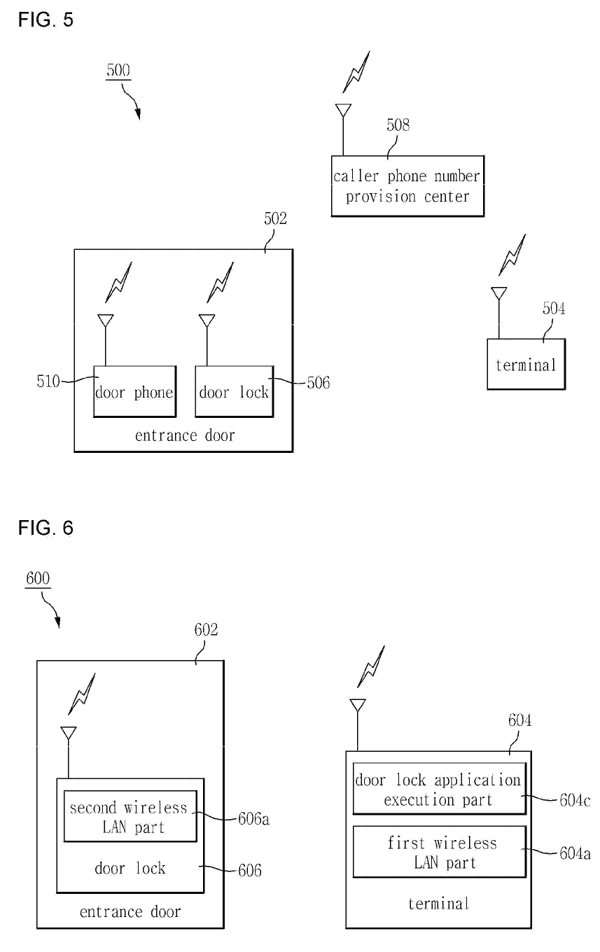

FIG. 5 is a block diagram of a door lock system according to a sixth preferred embodiment of the present invention.

Referring to FIG. 5, the door lock system 500 according to the sixth preferred embodiment of the present invention includes an entrance door 502, a terminal 504, a door lock 506, and a door phone 510.

The entrance door 502 is not illustrated in the drawing, but is provided at one side of a building (not shown).

The door lock 506 is provided at one side of the entrance door 502 for controlling opening and closing of the entrance door 502.

Moreover, the door lock 506 includes a network key previously set, and executes communication with the terminal 504 when the network key received from the terminal 504 is agreed with the previously set network key.

The terminal 504 executes communication with the door lock 506 so as to provide a communication signal to the door lock 506.

Here, the terminal 504 may be at least one of a telephone and a remote controller.

In this instance, in the case that the terminal 504 is the telephone, the terminal 504 may be at least one of a mobile communication terminal, a wire phone, a wire and wireless IP phone, and a smart phone.

Furthermore, in the case that the terminal 504 is the remote controller, the terminal 504 may be at least one of a PC having a phone number, a mobile PC having a phone number, and a special device having a phone number.

In this instance, in the case that the terminal 504 is the remote controller, the terminal 504 may include at least one of a PSTN phone module (not shown), a mobile communication phone module (not shown), and a wire and wireless IP phone module (not shown).

Additionally, the terminal 504 may manipulate the door lock 506 remotely so as to register a phone number of a new terminal, and can check, change and delete the phone number of the terminal which has been previously registered in the door lock 506.

Here, the door lock system 500 according to the sixth preferred embodiment of the present invention may include a door phone 510 provided at the other side of the building (not shown).

Moreover, the terminal 504 of the door lock system 500 according to the sixth preferred embodiment of the present invention may include a phone number provided by the communication service provider corresponding to the communication signal.

Furthermore, the door lock system 500 according to the sixth preferred embodiment of the present invention may further include a caller phone number provision center 508.

That is, the caller phone number provision center 508 executes communication with the terminal 504 so as to provide the phone number, which is provided by the communication service provider and sent from the terminal 504, as a caller identification service (CID: Caller ID).

Furthermore, the door lock 506 of the door lock system 500 according to the sixth preferred embodiment of the present invention may include a phone number provided by the communication service provider and a phone number of the previously registered terminal 504, and execute communication with the door phone 510 and the caller phone number provision center 508.

When a visitor tries to open the entrance door 502 by a call signal through the door phone 510, the door lock 506 makes a call to the terminal 504 having the phone number of the previously registered terminal 504 in synchronism with the call signal.

After that, in the case that the user of the terminal 504 having the phone number of the previously registered terminal 504 checks the visitor by a voice or an image through the door phone 510 and allows the visitor access, the terminal 504 makes a call to the door lock 506 after the user of the terminal 504 hangs up on the visitor.

After that, when the phone number received from the caller phone number provision center 508 is agreed with one of the phone numbers of the previously registered terminal 504, the door lock 506 is unlocked.

In the meantime, not shown in the drawing, but the entrance door 502, the terminal 504, the door lock 506, the caller phone number provision center 508, and the door phone 510 of the door lock system 500 according to the sixth preferred embodiment of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 506 of the door lock system 500 according to the sixth preferred embodiment of the present invention may include an Internet sharer (not shown), which is means for sharing the Internet, in an integrated type or a separated type.

### Embodiments 7, 8 and 9

FIG. 6 is a block diagram of a door lock system according to seventh, eighth and ninth preferred embodiments of the present invention.

Referring to FIG. 6, the door lock system 600 according to the seventh, eighth and ninth preferred embodiments of the present invention includes an entrance door 602, a terminal 604, and a door lock 606.

The entrance door 602 is not illustrated in the drawing, but is provided at one side of a building (not shown).

The door lock 606 is provided at one side of the entrance door 602 for controlling opening and closing of the entrance door 602.

Moreover, the door lock 606 includes a network key previously set, and executes communication with the terminal 604 when the network key received from the terminal 604 is agreed with the previously set network key.

The terminal 604 executes communication with the door lock 606 so as to provide a communication signal to the door lock 606.

Here, the terminal 604 may be at least one of a telephone and a remote controller.

In this instance, in the case that the terminal 604 is the telephone, the terminal 604 may be at least one of a mobile communication terminal, a wire phone, a wire and wireless IP phone, and a smart phone.

Furthermore, in the case that the terminal 604 is the remote controller, the terminal 604 may be at least one of a PC having a phone number, a mobile PC having a phone number, and a special device having a phone number.

In this instance, in the case that the terminal 604 is the remote controller, the terminal 604 may include at least one of a PSTN phone module (not shown), a mobile communication phone module (not shown), and a wire and wireless IP phone module (not shown).

Additionally, the terminal 604 may manipulate the door lock 606 remotely so as to register a new secrete access number, and can check, change and delete the secrete access number which has been previously registered in the door lock 606.

Here, the terminal 604 of the door lock system 600 according to the seventh preferred embodiment of the present invention may further include a first wireless LAN part 604a for sending identification information corresponding to the communication signal and an application execution part 604c for controlling the door lock 606 in communication with the door lock 606 so as to execute a door lock application.

Moreover, the door lock 606 of the door lock system 600 according to the seventh preferred embodiment of the present invention may further include a second wireless LAN part 606a having identification information of the previously registered terminal 604 for executing communication with the first wireless LAN part 604a.

In this instance, the identification information may include at least one of MAC (Media Access Control) address and an IMEI (International Mobile Equipment Identity).

In the case the user of the terminal 604 is in a communication range, when the identification information sent by the first wireless LAN part 604a of the terminal 604 and received through the second wireless LAN part 606a is agreed with one of the identification information of the previously registered terminal 604, a door lock application execution signal is supplied to the terminal 604 and the application execution part 604c is executed, so that the door lock 606 of the door lock system 600 is controlled by the door lock application manipulated by the user.

In the meantime, the terminal 604 of the door lock system 600 according to the eighth preferred embodiment of the present invention may further include a first wireless LAN part 604a for sending identification information and a secrete access number corresponding to the communication signal and an application execution part 604c for controlling the door lock 606 in communication with the door lock 606 so as to execute a door lock application.

Moreover, the door lock 606 of the door lock system 600 according to the eighth preferred embodiment of the present invention may further include a second wireless LAN part 606a having identification information of the previously registered terminal 604 and the previously registered secrete access number for executing communication with the first wireless LAN part 604a.

In this instance, the identification information may include at least one of MAC (Media Access Control) address and an IMEI (International Mobile Equipment Identity).

In the case the user of the terminal 604 is in a communication range, when the identification information sent by the first wireless LAN part 604a of the terminal 604 and received through the second wireless LAN part 606a is agreed with one of the identification information of the previously registered terminal 604, a door lock application execution signal is supplied to the terminal 604 and the application execution part 604c is executed.

After that, when a secrete access number agreeing with one of the previously registered secrete access numbers of the terminal 604 using the door lock application is inputted, the door lock 606 of the door lock system 600 according to the eighth preferred embodiment of the present invention is controlled by the door lock application manipulated by the user.

In the meantime, the terminal 604 of the door lock system 600 according to the ninth preferred embodiment of the present invention may further include a first wireless LAN part 604a for sending identification information corresponding to the communication signal and an application execution part 604c having a previously registered secrete number for controlling the door lock 606 in communication with the door lock 606 so as to execute a door lock application.

Moreover, the door lock 606 of the door lock system 600 according to the ninth preferred embodiment of the present invention may further include a second wireless LAN part 606a having identification information of the previously registered terminal 604 for executing communication with the first wireless LAN part 604a.

In this instance, the identification information may include at least one of MAC (Media Access Control) address and an IMEI (International Mobile Equipment Identity).

In the case the user of the terminal 604 is in a communication range, when the identification information sent by the first wireless LAN part 604a of the terminal 604 and received through the second wireless LAN part 606a is agreed with one of the identification information of the previously registered terminal 604, a door lock application execution signal is supplied to the terminal 604 and the application execution part 604c is executed.

After that, when a secrete access number agreeing with one of the previously registered secrete access numbers of the terminal 604 using the door lock application is inputted, the door lock 606 of the door lock system 600 according to the ninth preferred embodiment of the present invention is controlled by the door lock application manipulated by the user.

In the meantime, not shown in the drawing, but the entrance door 602, the terminal 604 and the door lock 606 of the door lock system 600 according to the seventh, eighth and ninth preferred embodiments of the present invention can execute communication with one another by at least one of the wire communication method and the wireless communication method. In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 606 of the door lock system 600 according to the seventh, eighth and ninth preferred embodiments of the present invention may include an Internet sharer (not shown), which is means for sharing the Internet, in an integrated type or a separated type.

### Embodiments 10, 11 and 12

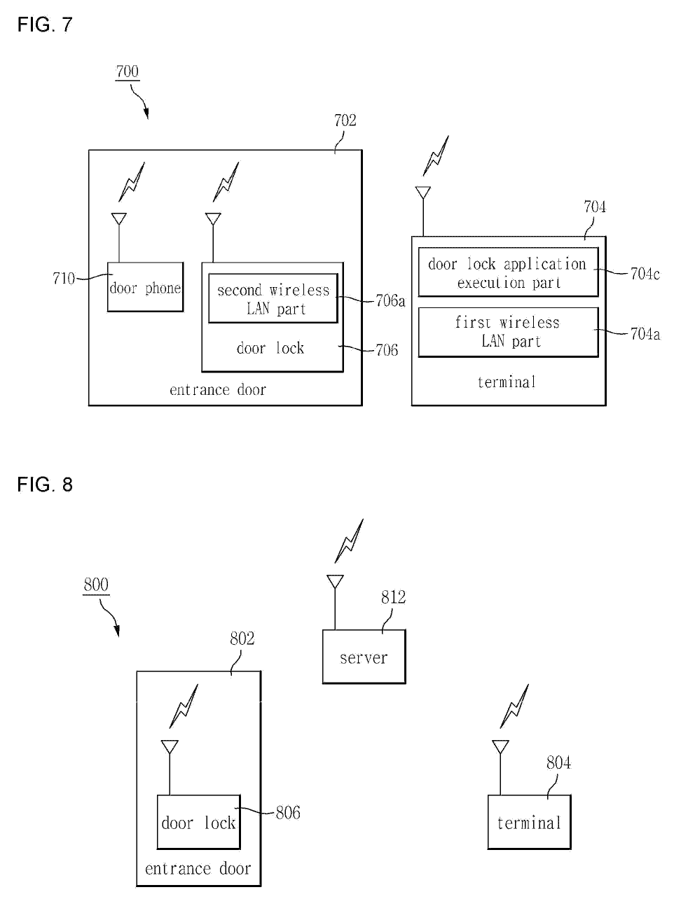

FIG. 7 is a block diagram of a door lock system according to tenth, eleventh and twelfth preferred embodiments of the present invention.

Referring to FIG. 7, the door lock system 700 according to the tenth, eleventh and twelfth preferred embodiments of the present invention includes an entrance door 702, a terminal 704, a door lock 706, and a door phone 710.

The entrance door 702 is not illustrated in the drawing, but is provided at one side of a building (not shown).

The door lock 706 is provided at one side of the entrance door 702 for controlling opening and closing of the entrance door 702.

Moreover, the door lock 706 includes a network key previously set, and executes communication with the terminal 704 when the network key received from the terminal 704 is agreed with the previously set network key.

The terminal 704 executes communication with the door lock 706 so as to provide a communication signal to the door lock 706.

Here, the terminal 704 may be at least one of a telephone and a remote controller.

In this instance, in the case that the terminal 704 is the telephone, the terminal 704 may be at least one of a mobile communication terminal, a wire phone, a wire and wireless IP phone, and a smart phone.

Furthermore, in the case that the terminal 704 is the remote controller, the terminal 704 may be at least one of a PC having a phone number, a mobile PC having a phone number, and a special device having a phone number.

In this instance, in the case that the terminal 704 is the remote controller, the terminal 704 may include at least one of a PSTN phone module (not shown), a mobile communication phone module (not shown), and a wire and wireless IP phone module (not shown).

Additionally, the terminal 704 may manipulate the door lock 706 remotely so as to register a new secrete access number, and can check, change and delete the secrete access number which has been previously registered in the door lock 706.

Here, the terminal 704 of the door lock system 700 according to the tenth preferred embodiment of the present invention may further include a first wireless LAN part 704a for sending identification information corresponding to the communication signal and an application execution part 704c for controlling the door lock 706 in communication with the door lock 706 so as to execute a door lock application.

Moreover, the door lock 706 of the door lock system 600 according to the tenth preferred embodiment of the present invention may further include a second wireless LAN part 706a having identification information of the previously registered terminal 704 for executing communication with the first wireless LAN part 704a.

In this instance, the identification information may include at least one of MAC (Media Access Control) address and an IMEI (International Mobile Equipment Identity).

In the case the user of the terminal 704 is in a communication range, when the identification information sent by the first wireless LAN part 704a of the terminal 704 and received through the second wireless LAN part 706a is agreed with one of the identification information of the previously registered terminal 704, a door lock application execution signal is supplied to the terminal 704 and the application execution part 704c is executed, so that the door lock 706 of the door lock system 700 according to the tenth preferred embodiment of the present invention is controlled by the door lock application manipulated by the user.

The door lock system 700 according to the tenth preferred embodiment of the present invention may further include a door phone 710.

That is, the door phone 710 is provided at the other side of the building (not shown) having the door lock 706, and executes communication with the door lock 706.

In this instance, the user of the terminal 704 checks the visitor by a voice or an image through the door lock application execution part 704a provided from the door phone 710 using the door lock application.

In the meantime, the terminal 704 of the door lock system 700 according to the eleventh preferred embodiment of the present invention may further include a first wireless LAN part 704a for sending identification information and a secrete access number corresponding to the communication signal and an application execution part 704c for controlling the door lock 706 in communication with the door lock 706 so as to execute a door lock application.

Moreover, the door lock 706 of the door lock system 700 according to the eleventh preferred embodiment of the present invention may further include a second wireless LAN part 706a having identification information of the previously registered terminal 604 and the previously registered secrete access number for executing communication with the first wireless LAN part 704a.

In this instance, the identification information may include at least one of MAC (Media Access Control) address and an IMEI (International Mobile Equipment Identity).

In the case the user of the terminal 704 is in a communication range, when the identification information sent by the first wireless LAN part 704a of the terminal 704 and received through the second wireless LAN part 706a is agreed with one of the identification information of the previously registered terminal 704, a door lock application execution signal is supplied to the terminal 704 and the application execution part 704c is executed.

After that, when a secrete access number agreeing with one of the previously registered secrete access numbers of the terminal 704 using the door lock application is inputted, the door lock 706 of the door lock system 700 according to the eleventh preferred embodiment of the present invention is controlled by the door lock application manipulated by the user.

The door lock system 700 according to the eleventh preferred embodiment of the present invention may further include a door phone 710.

That is, the door phone 710 is provided at the other side of the building (not shown) having the door lock 706, and executes communication with the door lock 706.

In this instance, the user of the terminal 704 checks the visitor by a voice or an image through the door lock application execution part 704a provided from the door phone 710 using the door lock application.

In the meantime, the terminal 704 of the door lock system 700 according to the twelfth preferred embodiment of the present invention may further include a first wireless LAN part 704a for sending identification information corresponding to the communication signal and an application execution part 704c having a previously registered secrete access number for controlling the door lock 706 in communication with the door lock 706 so as to execute a door lock application.

Moreover, the door lock 706 of the door lock system 700 according to the twelfth preferred embodiment of the present invention may further include a second wireless LAN part 706a having identification information of the previously registered terminal 604 for executing communication with the first wireless LAN part 704a.

In this instance, the identification information may include at least one of MAC (Media Access Control) address and an IMEI (International Mobile Equipment Identity).

In the case the user of the terminal 704 is in a communication range, when the identification information sent by the first wireless LAN part 704a of the terminal 704 and received through the second wireless LAN part 706a is agreed with one of the identification information of the previously registered terminal 704, a door lock application execution signal is supplied to the terminal 704 and the application execution part 704c is executed.

After that, when a secrete access number agreeing with one of the previously registered secrete access numbers of the terminal 704 using the door lock application is inputted, the door lock 706 of the door lock system 700 according to the twelfth preferred embodiment of the present invention is controlled by the door lock application manipulated by the user.

The door lock system 700 according to the twelfth preferred embodiment of the present invention may further include a door phone 710.

That is, the door phone 710 is provided at the other side of the building (not shown) having the door lock 706, and executes communication with the door lock 706.

In this instance, the user of the terminal 704 checks the visitor by a voice or an image through the door lock application execution part 704c provided from the door phone 710 using the door lock application.

In the meantime, the entrance door 702, the terminal 704, the door lock 706, and the door phone 710 of the door lock system 700 according to the tenth, eleventh and twelfth preferred embodiments of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 706 of the door lock system 700 according to the tenth, eleventh and twelfth preferred embodiments of the present invention may include an Internet sharer (not shown), which is means for sharing the Internet, in an integrated type or a separated type.

### Embodiments 13 and 14

FIG. 8 is a block diagram of a door lock system according to thirteenth and fourteenth preferred embodiments of the present invention.

Referring to FIG. 8, the door lock system 800 according to the thirteenth and fourteenth preferred embodiments of the present invention includes an entrance door 802, a terminal 804, a door lock 806, and a server 812.

The entrance door 802 is not illustrated in the drawing, but is provided at one side of a building (not shown).

The door lock 806 is provided at one side of the entrance door 802 for controlling opening and closing of the entrance door 802.

Moreover, the door lock 806 includes a network key previously set, and executes communication with the terminal 804 when the network key received from the terminal 804 is agreed with the previously set network key.

The terminal 804 executes communication with the door lock 806 so as to provide a communication signal to the door lock 806.

Here, the terminal 804 may be at least one of a telephone and a remote controller.

In this instance, in the case that the terminal 804 is the telephone, the terminal 804 may be at least one of a mobile communication terminal, a wire phone, a wire and wireless IP phone, and a smart phone.

Furthermore, in the case that the terminal 804 is the remote controller, the terminal 804 may be at least one of a PC having a phone number, a mobile PC having a phone number, and a special device having a phone number.

In this instance, in the case that the terminal 804 is the remote controller, the terminal 804 may include at least one of a PSTN phone module (not shown), a mobile communication phone module (not shown), and a wire and wireless IP phone module (not shown).

Here, the door lock system 800 according to the thirteenth and fourteenth preferred embodiments of the present invention may further include a server 812.

That is, the server 812 is provided to relay communication between the terminal 804 and the door lock 806.

In this instance, the door lock 806 of the door lock system 800 according to the thirteenth preferred embodiment executes communication with the terminal 804 by relay of the server 812 when receiving communication from the server 812 by connection of the terminal 804 through the server 812 in a state where it is periodically connected to the server 812.

That is, the door lock 806 of the door lock system 800 according to the thirteenth preferred embodiment executes communication with the terminal 804 by relay of the server 812, and then, can check, change or delete the phone number of the previously registered terminal 804.

In this instance, the terminal 804 manipulates the door lock 806 remotely so as to register a phone number of a new terminal 804.

Moreover, the terminal 804 can manipulate the door lock 806 so as to register a new secrete access number and can check, change or delete the previously registered secrete access number.

Furthermore, the terminal 804 may provide identification information of the terminal 804 to the door lock 806.

In this instance, the identification information may include at least one of MAC (Media Access Control) address and an IMEI (International Mobile Equipment Identity).

Additionally, the door lock 806 is unlocked when the identification information received from the terminal 804 is agreed with one of the identification information previously registered in the door lock 806.

Moreover, the terminal 804 may send the secrete access number to the door lock 806.

In this instance, the door lock 806 is unlocked when the secrete access number received from the terminal 804 is agreed with one of the secrete access numbers previously registered in the door lock 806.

Furthermore, not shown in the drawing, but the terminal 804 may be provided in such a manner that the user of the terminal 804 checks the visitor by a voice or an image through the door phone (not shown) communicating with the door lock 806.

In this instance, in the case that the user of the terminal 804 allows the visitor access, the door lock 806 is unlocked when the user selectively presses the previously designated entrance door opening button (not shown).

Additionally, not shown in the drawing, but the terminal 804 may further include a door lock application execution part (not shown) for executing a door lock application to control the door lock 806.

In the meantime, in a state where it is periodically connected to the server 812, the terminal 804 of the door lock system 800 according to the fourteenth preferred embodiment executes communication with the door lock 806 by relay of the server 812 when receiving communication from the server 812 by connection of the terminal 804 through the server 812 synchronized when the visitor tries to open the entrance door 802.

That is, the terminal 804 of the door lock system 800 according to the fourteenth preferred embodiment executes communication with the door lock 806 by relay of the server 812, and then, can check, change or delete the phone number of the previously registered terminal 804.

In this instance, the terminal 804 manipulates the door lock 806 remotely so as to register a phone number of a new terminal 804.

Moreover, the terminal 804 can manipulate the door lock 806 so as to register a new secrete access number and can check, change or delete the previously registered secrete access number.

Furthermore, the terminal 804 may provide identification information of the terminal 804 to the door lock 806.

In this instance, the identification information may include at least one of MAC (Media Access Control) address and an IMEI (International Mobile Equipment Identity).

Additionally, the door lock 806 is unlocked when the identification information received from the terminal 804 is agreed with one of the identification information previously registered in the door lock 806.

Moreover, the terminal 804 may send the secrete access number to the door lock 806.

In this instance, the door lock 806 is unlocked when the secrete access number received from the terminal 804 is agreed with one of the secrete access numbers previously registered in the door lock 806.

Furthermore, not shown in the drawing, but the terminal 804 may be provided in such a manner that the user of the terminal 804 checks the visitor by a voice or an image through the door phone (not shown) communicating with the door lock 806.

In this instance, in the case that the user of the terminal 804 allows the visitor access, the door lock 806 is unlocked when the user selectively presses the previously designated entrance door opening button (not shown).

Additionally, not shown in the drawing, but the terminal 804 may further include a door lock application execution part (not shown) for executing a door lock application to control the door lock 806.

In the meantime, not shown in the drawing, but the entrance door 802, the terminal 804, the door lock 806, and the server 812 of the door lock system 800 according to the thirteenth and fourteenth preferred embodiments of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 806 of the door lock system 800 according to the thirteenth and fourteenth preferred embodiments of the present invention may include an Internet sharer (not shown), which is means for sharing the Internet, in an integrated type or a separated type.

### Embodiments 15 and 16

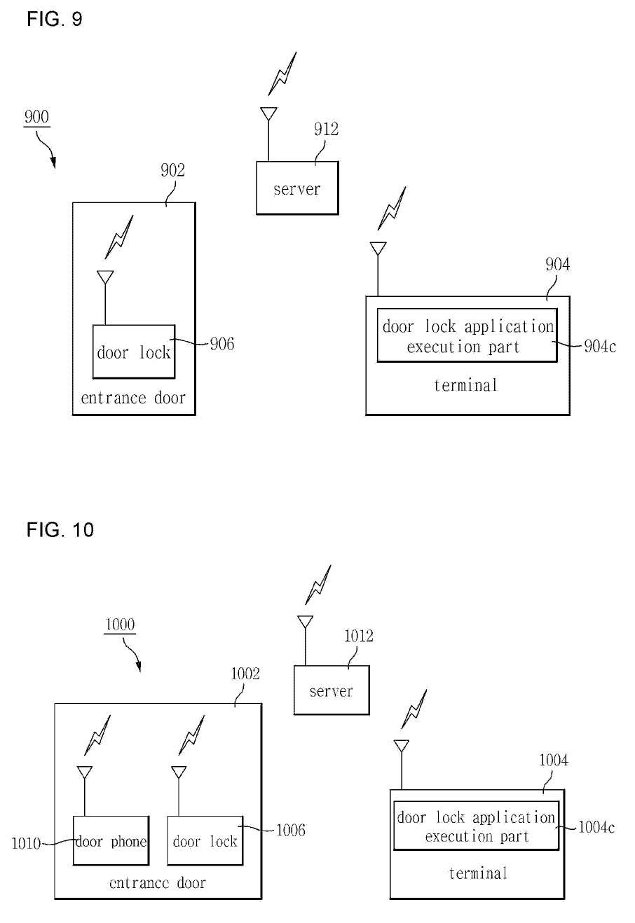

FIG. 9 is a block diagram of a door lock system according to fifteenth and sixteenth preferred embodiments of the present invention.

Referring to FIG. 9, the door lock system 900 according to the fifteenth and sixteenth preferred embodiments of the present invention includes an entrance door 902, a terminal 904, a door lock 906, and a server 912.

The entrance door 902 is not illustrated in the drawing, but is provided at one side of a building (not shown).

The door lock 906 is provided at one side of the entrance door 902 for controlling opening and closing of the entrance door 902.

Moreover, the door lock 906 includes a network key previously set, and executes communication with the terminal 904 when the network key received from the terminal 904 is agreed with the previously set network key.

The terminal 904 executes communication with the door lock 906 so as to provide a communication signal to the door lock 906.

Here, the terminal 904 may be at least one of a telephone and a remote controller.

In this instance, in the case that the terminal 904 is the telephone, the terminal 904 may be at least one of a mobile communication terminal, a wire phone, a wire and wireless IP phone, and a smart phone.

Furthermore, in the case that the terminal 904 is the remote controller, the terminal 904 may be at least one of a PC having a phone number, a mobile PC having a phone number, and a special device having a phone number.

In this instance, in the case that the terminal 904 is the remote controller, the terminal 904 may include at least one of a PSTN phone module (not shown), a mobile communication phone module (not shown), and a wire and wireless IP phone module (not shown).

Moreover, the terminal 904 can manipulate the door lock 906 remotely so as to register a new secrete access number and can check, change or delete the secrete access number previously registered in the door lock 906.

Here, the terminal 904 of the door lock system 900 according to the fifteenth preferred embodiment of the present invention may further include a door lock application execution part 904c for executing a door lock application to communicate with the door lock 906 and control the door lock 906.

Furthermore, the door lock system 900 according to the fifteenth preferred embodiment of the present invention may further include a server 912.

That is, the server 9812 is provided to relay communication between the terminal 904 and the door lock 906.

In this instance, the door lock 906 is synchronized when the visitor tries to open the entrance door 902 and sends the door lock application execution signal to the terminal 904 by connection of the terminal 904 to the service 912 so as to execute the door lock application execution part 904c, so that the user of the terminal 904 can control the door lock 906 using the door lock application by relay of the server 912.

Moreover, the door lock system 900 according to the sixteenth preferred embodiment of the present invention may further include a server 912.

That is, the server 912 is provided to relay communication between the terminal 904 and the door lock 906.

In this instance, the door lock 906 is synchronized when the visitor tries to open the entrance door 902 and sends the door lock application execution signal to the terminal 904 by connection of the terminal 904 to the service 912 so as to execute the door lock application execution part 904c.

After that, when a secrete access number agreeing with one of the previously registered secrete access numbers of the terminal 904 using the door lock application is inputted, the door lock 906 of the door lock system 900 is controlled by the door lock application manipulated by the user.

In the meantime, the entrance door 902, the terminal 904, the door lock 906, and the server 912 of the door lock system 900 according to the fifteenth and sixteenth preferred embodiments of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 906 of the door lock system 900 according to the fifteenth and sixteenth preferred embodiments of the present invention may include an Internet sharer (not shown), which is means for sharing the Internet, in an integrated type or a separated type.

### Embodiments 17, 18, 19 and 20

FIG. 10 is a block diagram of a door lock system according to seventeenth, eighteenth, nineteenth and twentieth preferred embodiments of the present invention.

Referring to FIG. 10, the door lock system 900 according to the seventeenth, eighteenth, nineteenth and twentieth preferred embodiments of the present invention includes an entrance door 1002, a terminal 1004, a door lock 1006, a door phone 1010 and a server 1012.

The entrance door 1002 is not illustrated in the drawing, but is provided at one side of a building (not shown).

The door lock 1006 is provided at one side of the entrance door 1002 for controlling opening and closing of the entrance door 1002.

Moreover, the door lock 1006 includes a network key previously set, and executes communication with the terminal 1004 when the network key received from the terminal 1004 is agreed with the previously set network key.

The terminal 1004 executes communication with the door lock 1006 so as to provide a communication signal to the door lock 1006.

Here, the terminal 1004 may be at least one of a telephone and a remote controller.

In this instance, in the case that the terminal 1004 is the telephone, the terminal 1004 may be at least one of a mobile communication terminal, a wire phone, a wire and wireless IP phone, and a smart phone.

Furthermore, in the case that the terminal 1004 is the remote controller, the terminal 1004 may be at least one of a PC having a phone number, a mobile PC having a phone number, and a special device having a phone number.

In this instance, in the case that the terminal 1004 is the remote controller, the terminal 1004 may include at least one of a PSTN phone module (not shown), a mobile communication phone module (not shown), and a wire and wireless IP phone module (not shown).

In addition, the terminal 1004 can manipulate the door lock 906 remotely so as to register a phone number of a new terminal, and can check, change or delete the phone number of the terminal previously registered in the door lock 1006.

Moreover, the terminal 1004 can manipulate the door lock 1006 remotely so as to register a new secrete access number and can check, change or delete the secrete access number previously registered in the door lock 1006.

Here, the terminal 1004 of the door lock system 1000 according to the seventeenth preferred embodiment of the present invention may further include a door lock application execution part 1004c for executing a door lock application to communicate with the door lock 906 and control the door lock 1006.

Furthermore, the door lock system 1000 according to the seventeenth preferred embodiment of the present invention may further include a server 1012.

That is, the server 1012 is provided to relay communication between the terminal 1004 and the door lock 1006.

In this instance, the door lock 1006 is synchronized when the visitor tries to open the entrance door 1002 and sends the door lock application execution signal to the terminal 1004 by connection of the terminal 1004 to the service 1012 so as to execute the door lock application execution part 1004c, so that the user of the terminal 1004 can control the door lock 1006 using the door lock application by relay of the server 1012.

Furthermore, the door lock system 1000 according to the seventeenth preferred embodiment of the present invention may include a door phone 1010.

That is, the door phone 1010 is provided at the other side of the building (not shown) for executing communication with the door lock 1006.

In this instance, the user of the terminal 1004 checks the visitor by a voice or an image through the door lock application execution part 1004c provided from the door phone 1010 using the door lock application.

In the meantime, the terminal 1004 of the door lock system 1000 according to the eighteenth preferred embodiment of the present invention may further include a door lock application execution part 1004c for executing a door lock application to communicate with the door lock 906 and control the door lock 1006.

Furthermore, the door lock system 1000 according to the seventeenth preferred embodiment of the present invention may further include a server 1012.

That is, the server 1012 is provided to relay communication between the terminal 1004 and the door lock 1006.

In this instance, the door lock 1006 includes a previously registered secrete access number, and is synchronized when the visitor tries to open the entrance door 1002 and sends the door lock application execution signal to the terminal 1004 by connection of the terminal 1004 to the service 1012 so as to execute the door lock application execution part 1004c.

After that, when a secrete access number agreeing with one of the previously registered secrete access numbers of the terminal 1004 using the door lock application is inputted, the door lock 1006 of the door lock system 1000 is controlled by the door lock application manipulated by the user.

Moreover, the door lock system 1000 according to the eighteenth preferred embodiment may further include a door phone 1010.

That is, the door phone 1010 is provided at the other side of the building (not shown) for executing communication with the door lock 1006.

In this instance, the user of the terminal 1004 checks the visitor by a voice or an image through the door lock application execution part 1004c provided from the door phone 1010 using the door lock application.

Meanwhile, the door lock system 1000 according to the nineteenth preferred embodiment may further include a door phone 1010 provided at the other side of the building (not shown).

Moreover, the terminal 1004 of the door lock system 1000 according to the nineteenth preferred embodiment of the present invention may further include a door lock application execution part 1004c for executing a door lock application to communicate with the door lock 906 and control the door lock 1006.

Furthermore, the door lock system 1000 according to the nineteenth preferred embodiment of the present invention may further include a server 1012.

That is, the server 1012 is provided to relay communication between the terminal 1004 and the door lock 1006.

In this instance, the door lock 1006 of the door lock system 1000 according to the nineteenth preferred embodiment includes a phone number provided by a communication service provider and a phone number of a previously registered terminal 1004 so as to execute communication with the terminal 1004 and the door phone 1010.

The door lock 1006 is synchronized to a call signal when the visitor tries to open the entrance door 1002 by the call signal through the door phone 1010, and makes a call to the terminal 1004 having the phone number of the previously registered terminal 1004.

After that, in a state where the door lock 1006 is periodically connected to the server 1012, the door lock 1006 receives communication from the server 1012 through the connection of the terminal 1004 to the server 1012 synchronized when the user of the terminal 1004 executes the door lock application execution part 1004c by providing a door lock application execution single to the terminal 1004, the user of the terminal 1004 can control the door lock 1006 using the door lock application by relay of the server 1012.

In this instance, the user of the terminal 1004 checks the visitor by a voice or an image through the door lock application execution part 1004c provided from the door phone 1010 using the door lock application.

In the meantime, the door lock system 1000 according to the twentieth preferred embodiment may further include a door phone 1010 provided at the other side of the building (not shown).

Moreover, the terminal 1004 of the door lock system 1000 according to the nineteenth preferred embodiment of the present invention may further include a door lock application execution part 1004c for executing a door lock application to communicate with the door lock 906 and control the door lock 1006.

Furthermore, the door lock system 1000 according to the nineteenth preferred embodiment of the present invention may further include a server 1012.

That is, the server 1012 is provided to relay communication between the terminal 1004 and the door lock 1006.

In this instance, the door lock 1006 of the door lock system 1000 according to the nineteenth preferred embodiment includes a phone number provided by a communication service provider and a phone number of a previously registered terminal 1004 so as to execute communication with the door phone 1010.

The door lock 1006 is synchronized to a call signal when the visitor tries to open the entrance door 1002 by the call signal through the door phone 1010, and makes a call to the terminal 1004 having the phone number of the previously registered terminal 1004.

After that, in a state where the door lock 1006 is periodically connected to the server 1012, the door lock 1006 receives communication from the server 1012 through the connection of the terminal 1004 to the server 1012 synchronized when the user of the terminal 1004 executes the door lock application execution part 1004c by providing a door lock application execution single to the terminal 1004.

After that, when a secrete access number agreeing with one of the previously registered secrete access numbers of the terminal 1004 using the door lock application is inputted, the door lock 1006 of the door lock system 1000 is controlled by the door lock application manipulated by the user.

In this instance, the user of the terminal 1004 checks the visitor by a voice or an image through the door lock application execution part 1004c provided from the door phone 1010 using the door lock application.

In the meantime, the entrance door 1002, the terminal 1004, the door lock 1006, and the server 1012 of the door lock system 1000 according to the seventeenth, eighteenth, nineteenth and twentieth preferred embodiments of the present invention can execute communication with one another by at least one of the wire communication method and the wireless communication method.

In this instance, the wireless communication method is executed through at least one of WiFi connection, WiFi direct connection, and binary CDMA connection.

Moreover, the wireless communication method can execute communication through a mobile phone network or a wireless Internet phone network based on at least one of CDMA, GSM, WCDMA, LTE, Wibro, and Wimax, and the wire communication method can execute communication through a wire phone network or a wire Internet phone network.

In this instance, not shown in the drawing, but the door lock 1006 of the door lock system 1000 according to the seventeenth, eighteenth, nineteenth and twentieth preferred embodiments of the present invention may include an Internet sharer (not shown), which is means for sharing the Internet, in an integrated type or a separated type.

It will be understood by those of ordinary skill in the art that the present invention could be made in other forms without changing the essential characteristics and scope of the present invention. Therefore, it would be understood that the embodiments of the present invention have been described exemplarily and the present invention is not limited to the above embodiments. It would be understood that the technical and protective scope of the present invention should be defined by the technical idea as defined by the following claims, and the example embodiments of the present invention are to cover all modifications, equivalents, and alternatives derived from the meaning, scope and equivalent concepts of the scope of the invention.

1. A door lock system comprising:
an entrance door provided at one side of a building;
a door lock provided at one side of the entrance door for controlling opening and closing of the entrance door; and
a terminal for providing a communication signal to the door lock through communication with the door lock.

2. The door lock system according to claim 1, wherein the terminal includes:
a phone number provided from a communication service provider corresponding to a communication signal; and
a caller phone number provision center executing communication with the terminal for providing the phone number provided from the communication service provider as a caller identification service (CID: Caller ID),
wherein the door lock includes the phone number provided from the communication service provider and a phone number of a previously registered terminal, executes communication with the caller phone number provision center, and then, is unlocked in the case that the phone number received from the caller phone number provision center is agreed with one of the phone numbers of the previously registered terminal, when it gets a phone call from the terminal.

3. The door lock system according to claim 1, wherein the terminal further includes a first wireless LAN part for sending a secrete access number corresponding to a communication signal, and wherein the door lock includes a previously registered secrete access number and a second wireless LAN part for executing communication with the first wireless LAN part, and is unlocked in the case that the secrete access number sent through the first wireless LAN part and received through the second wireless LAN part is agreed with one of the previously registered secrete access numbers.

4. The door lock system according to claim 1, further comprising: a door phone provided at the other side of the building, wherein the terminal includes a phone number provided by the communication service provider, and further includes a previously designated entrance door opening button corresponding to the communication signal for controlling the door lock in communication with the door lock, and wherein the door lock includes a phone number provided by the communication service provider and a phone number of the previously registered terminal, executes communication with the door phone, makes a call to the terminal having the phone number of the previously registered terminal in synchronism with a call signal when a visitor tries to open the entrance door by the call signal through the door phone, and in the case that the user of the terminal having the phone number of the previously registered terminal checks the visitor by a voice or an image through the door phone and allows the visitor access, is unlocked when the user of the terminal selectively presses the previously designated entrance door opening button while being on the phone.

5. The door lock system according to claim 1, further comprising: a door phone provided at the other side of the building, wherein the terminal includes: a phone number provided from a communication service provider corresponding to a communication signal; and
a caller phone number provision center executing communication with the terminal for providing the phone number provided from the communication service provider as a caller identification service (CID: Caller ID), and wherein the door lock includes the phone number provided from the communication service provider and a phone number of a previously registered terminal, executes communication with the door phone and the caller phone number provision center, makes a call to the terminal having the phone number of the previously registered terminal in synchronism with a call signal when a visitor tries to open the entrance door by the call signal through the door phone, and in the case that the user of the terminal having the phone number of the previously registered terminal checks the visitor by a voice or an image through the door phone and allows the visitor access, is unlocked in the case that the phone number received from the caller phone number provision center is agreed with one of the phone numbers of the previously registered terminal when it gets a call from the terminal after the visitor ends the call with the user.

6. The door lock system according to claim 1, wherein the terminal further includes a first wireless LAN part for sending identification information corresponding to a communication signal, and wherein the door lock includes identification information of a previously registered terminal and a second wireless LAN part for executing communication with the first wireless LAN part, and when the terminal is in a communication range, is unlocked in the case that identification information sent through the first wireless LAN part and received through the second wireless LAN part is agreed with one of identification information of the previously registered terminal.

7. The door lock system according to claim 1, wherein the terminal further includes a first wireless LAN part for sending identification information corresponding to a communication signal, and a door lock application execution part for executing a door lock application to communicate with the door lock and control the door lock, and wherein the door lock includes identification information of a previously registered terminal and a second wireless LAN part for executing communication with the first wireless LAN part, provides a door lock application execution signal to the terminal so as to execute the door lock application execution part in the case that identification information sent through the first wireless LAN part and received through the second wireless LAN part when the terminal is in a communication range is agreed with one of identification information of the previously registered terminal, and is controlled by a door lock application of the user's terminal.

8. The door lock system according to claim 1, wherein the terminal further includes a first wireless LAN part for sending identification information and a secrete access number corresponding to a communication signal, and a door lock application execution part for executing a door lock application to communicate with the door lock and control the door lock, and
wherein the door lock includes identification information of a previously registered terminal and a previously registered secrete access number and a second wireless LAN part for executing communication with the first wireless LAN part, provides a door lock application execution signal to the terminal so as to execute the door lock application execution part in the case that identification information sent through the first wireless LAN part and received through the second wireless LAN part when the terminal is in a communication range is agreed with one of identification information of the previously registered terminal, and is controlled by a door lock application of the user's terminal when the user of the terminal using the door lock application inputs a secrete access number agreeing with one of the previously registered secrete access numbers.

9. The door lock system according to claim 1, wherein the terminal further includes a first wireless LAN part for sending identification information corresponding to a communication signal, and a door lock application execution part having a previously registered secrete access number for executing a door lock application to communicate with the door lock and control the door lock, and wherein the door lock includes identification information of a previously registered terminal and a second wireless LAN part for executing communication with the first wireless LAN part, provides a door lock application execution signal to the terminal so as to execute the door lock application execution part in the case that identification information sent through the first wireless LAN part and received through the second wireless LAN part when the terminal is in a communication range is agreed with one of identification information of the previously registered terminal, and is controlled by a door lock application of the user's terminal when the user of the terminal using the door lock application inputs a secrete access number agreeing with one of the previously registered secrete access numbers.

10. The door lock system according to claim 1, further comprising a server for relaying communication between the terminal and the door lock, wherein the door lock is periodically connected to the server, and executes communication with the terminal through relay of the server when communication is requested from the server by a server connection of the terminal.

11. The door lock system according to claim 1, further comprising a server for relaying communication between the terminal and the door lock, wherein the terminal is periodically connected to the server, and executes communication with the door lock through relay of the server when communication is requested from the server by a server connection of the door lock.

12. The door lock system according to claim 1, further comprising:
a door lock application execution part for executing a door lock application to communicate with the door lock and control the door lock; and
a server for relaying communication between the terminal and the door lock, wherein the door lock is synchronized when a visitor tries to open the entrance door, provides a door lock application execution signal to the terminal by the server through the server connection of the terminal so as to execute the door lock application execution part, and is controlled by the door lock application through relay of the server.

13. The door lock system according to claim 1, further comprising:
a door lock application execution part for executing a door lock application to communicate with the door lock and control the door lock; and
a server for relaying communication between the terminal and the door lock, wherein the door lock includes a previously registered secrete access number, is synchronized when a visitor tries to open the entrance door, provides a door lock application execution signal to the terminal by the server through the server connection of the terminal so as to execute the door lock application execution part, and is controlled by the door lock application through relay of the server when a secrete access number agreeing with one of the previously registered secrete access numbers is inputted by the user's door lock application.

14. The door lock system according to claim 1, further comprising:
a door phone provided at the other side of the building;
a door lock application execution part for executing a door lock application to communicate with the door lock and control the door lock; and
a server for relaying communication between the terminal and the door lock, wherein the door lock includes the phone number provided from the communication service provider and a phone number of a previously registered terminal, executes communication with the terminal and the door phone, makes a call to the terminal having the phone number of the previously registered terminal in synchronism with a call signal when a visitor tries to open the entrance door by the call signal through the door phone, provides a door lock application execution signal to the terminal by the user of the terminal in a state where it is periodically connected to the server, and is controlled by the door lock application by the user of the terminal through relay of the server when communication is requested from the server by a server connection of the terminal synchronized when the door lock application execution part is executed.

15. The door lock system according to claim 1, further comprising:
a door phone provided at the other side of the building;
a door lock application execution part for executing a door lock application to communicate with the door lock and control the door lock; and
a server for relaying communication between the terminal and the door lock, wherein the door lock includes the phone number provided from the communication service provider, a phone number of a previously registered terminal and a previously registered phone number, executes communication with the door phone, makes a call to the terminal having the phone number of the previously registered terminal in synchronism with a call signal when a visitor tries to open the entrance door by the call signal through the door phone, provides a door lock application execution signal to the terminal by the user of the terminal in a state where it is periodically connected to the server, receives a request of communication from the server by a server connection of the terminal synchronized when the door lock application execution part is executed, and is controlled by the door lock application when the user of the terminal inputs a secrete access number agreeing with one of the previously registered secrete access numbers using the door lock application through relay of the server.

16. The door lock system according to claim 1, wherein the terminal manipulates the door lock remotely so as to register a phone number of a new terminal, and checks, changes or deletes the phone number of the terminal previously registered in the door lock.

17. The door lock system according to claim 1, wherein the terminal manipulates the door lock remotely so as to register a new secrete access number, and checks, changes or deletes the secrete access number previously registered in the door lock.

18. The door lock system according to claim 7, further comprising: a door phone provided at the other side of the building having the door lock for executing communication with the door lock, wherein the door lock application is provided to allow the user of the terminal to check one of a visitor's voice and image provided to the door lock application execution part.

19. The door lock system according to claim 14, wherein the door lock application is provided to allow the user of the terminal to check one of a visitor's voice and image provided to the door lock application execution part from the door phone.

20. The door lock system according to claim 1, wherein the door lock includes a previously set network key and executes communication with the terminal when a network key received from the terminal is agreed with the previously set network key.

21. The door lock system according to claim 1, wherein the terminal is one of a phone and a remote controller.
